(19) United States
(12) Patent Application Publication
(10) Pub. No.: US 2026/0089710 A1
(43) Pub. Date: Mar. 26, 2026

(54) MUTABILITY OF UPLINK COMMUNICATIONS

(71) Applicant: QUALCOMM Incorporated, San Diego, CA (US)

(72) Inventors: Gabi SARKIS, San Diego, CA (US); Diana MAAMARI, San Diego, CA (US); Kianoush HOSSEINI, San Diego, CA (US); Aria HASANZADEZONUZY, Jersey City, NJ (US); Marc WERNER, Heroldsberg (DE)

(21) Appl. No.: 18/894,707

(22) Filed: Sep. 24, 2024

(51) Int. Cl. H04W 72/1268

(52) U.S. Cl. CPC H04W 72/1268

(57) ABSTRACT

Certain aspects of the present disclosure provide techniques for uplink grant mutability. An example method for wireless communications includes obtaining an indication of a mutability associated with a first uplink resource allocation having one or more first transmission occasions; and transmitting first signaling in the one or more first transmission occasions based on the first uplink resource allocation and the indication of the mutability associated with the first uplink resource allocation.

### FIELD OF THE DISCLOSURE

Aspects of the present disclosure relate to wireless communications, and more particularly, to mutability of uplink communications.

### DESCRIPTION OF RELATED ART

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, or the like. Consequently, there exists a need for further improvements in wireless communications systems to overcome the aforementioned technical challenges and others.

### SUMMARY

One aspect provides a method for wireless communications by an apparatus. The method includes obtaining an indication of a mutability associated with a first uplink resource allocation having one or more first transmission occasions; and transmitting first signaling in the one or more first transmission occasions according to the first uplink resource allocation.

Another aspect provides a method for wireless communications by an apparatus. The method includes transmitting an indication of a mutability associated with a first uplink resource allocation having one or more first transmission occasions; and obtaining first signaling in the one or more first transmission occasions based on the first uplink resource allocation and the indication of the mutability associated with the first uplink resource allocation.

Another aspect provides an apparatus configured for wireless communications. The apparatus includes one or more memories and one or more processors coupled to the one or more memories. The one or more processors are configured to cause the apparatus to obtain an indication of a mutability associated with a first uplink resource allocation having one or more first transmission occasions; and transmit first signaling in the one or more first transmission occasions based on the first uplink resource allocation and the indication of the mutability associated with the first uplink resource allocation.

Another aspect provides an apparatus configured for wireless communications. The apparatus includes one or more memories and one or more processors coupled to the one or more memories. The one or more processors are configured to cause the apparatus to transmit an indication of a mutability associated with a first uplink resource allocation having one or more first transmission occasions; and obtain first signaling in the one or more first transmission occasions based on the first uplink resource allocation and the indication of the mutability associated with the first uplink resource allocation.

Another aspect provides an apparatus configured for wireless communications. The apparatus includes means for obtaining an indication of a mutability associated with a first uplink resource allocation having one or more first transmission occasions; and means for transmitting first signaling in the one or more first transmission occasions based on the first uplink resource allocation and the indication of the mutability associated with the first uplink resource allocation.

Another aspect provides an apparatus configured for wireless communications. The apparatus includes means for transmitting an indication of a mutability associated with a first uplink resource allocation having one or more first transmission occasions; and means for obtaining first signaling in the one or more first transmission occasions based on the first uplink resource allocation and the indication of the mutability associated with the first uplink resource allocation.

Other aspects provide: one or more apparatuses operable, configured, or otherwise adapted to perform any portion of any method described herein (e.g., such that performance may be by only one apparatus or in a distributed fashion across multiple apparatuses); one or more non-transitory, computer-readable media comprising instructions that, when executed by one or more processors of one or more apparatuses, cause the one or more apparatuses to perform any portion of any method described herein (e.g., such that instructions may be included in only one computer-readable medium or in a distributed fashion across multiple computer-readable media, such that instructions may be executed by only one processor or by multiple processors in a distributed fashion, such that each apparatus of the one or more apparatuses may include one processor or multiple processors, and/or such that performance may be by only one apparatus or in a distributed fashion across multiple apparatuses); one or more computer program products embodied on one or more computer-readable storage media comprising code for performing any portion of any method described herein (e.g., such that code may be stored in only one computer-readable medium or across computer-readable media in a distributed fashion); and/or one or more apparatuses comprising one or more means for performing any portion of any method described herein (e.g., such that performance would be by only one apparatus or by multiple apparatuses in a distributed fashion). By way of example, an apparatus may comprise a processing system, a device with a processing system, or processing systems cooperating over one or more networks. An apparatus may comprise one or more memories; and one or more processors configured to cause the apparatus to perform any portion of any method described herein. In some examples, one or more of the processors may be preconfigured to perform various functions or operations described herein without requiring configuration by software.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of an example base station and an example user equipment (UE).

FIGS. 4A, 4B, 4C, and 4D depict various example aspects of data structures for a wireless communications network.

FIG. 5 depicts an example wireless communications system including an example transmitter chain and an example receiver chain.

FIGS. 6A and 6B depict example schemes for communication of a mutability indication via an uplink grant.

FIGS. 6C and 6D depict example schemes for communication of a mutability indication via a control message.

FIG. 7 depicts a process flow for communication of a mutability indication associated with an uplink resource allocation.

FIG. 8 depicts a method for wireless communications.

FIG. 9 depicts another method for wireless communications.

FIG. 10 depicts aspects of an example communications device.

FIG. 11 depicts aspects of an example communications device.

### DETAILED DESCRIPTION

Aspects of the present disclosure provide apparatuses, methods, processing systems, and computer-readable mediums for uplink grant mutability.

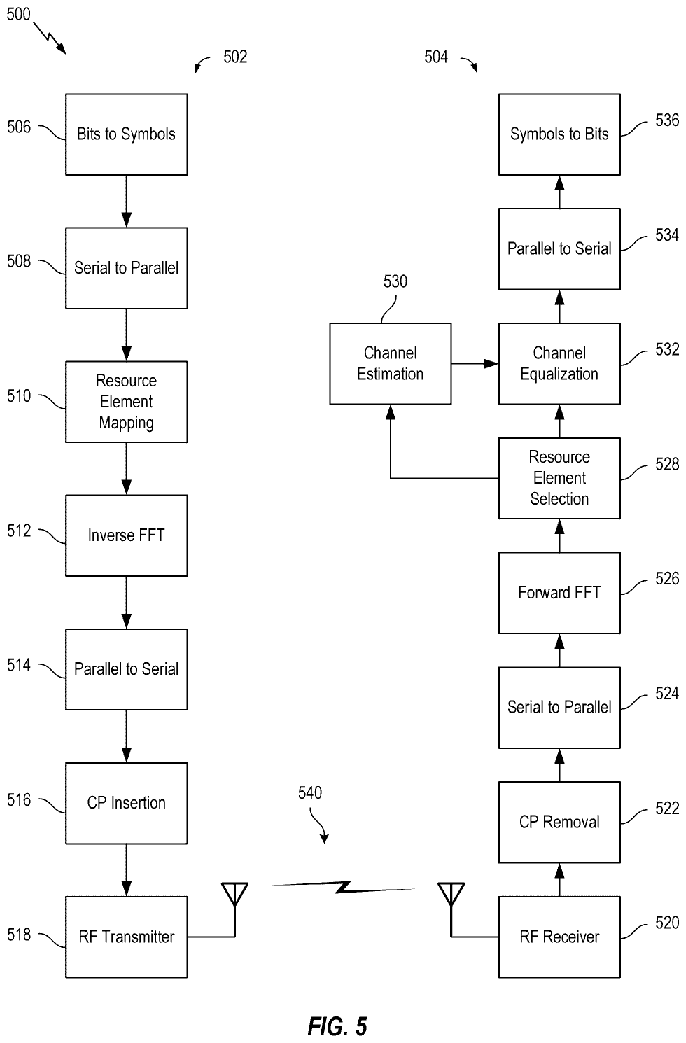

Certain wireless communications systems (e.g., 5G New Radio (NR) systems and/or any future wireless communications systems) may perform signal processing operations for signal transmissions, for example, as further described herein with respect to FIG. 5. As an example, a transmitter (such as such as a user equipment (UE)) may convert information into symbols of a digital modulation scheme, where a symbol may be a specific waveform that represents certain binary information. The transmitter may map the symbols to one or more multiple input and multiple output (MIMO) layers. The transmitter may perform precoding (e.g., channel and/or digital beamforming) in order to spatially multiplex the transmission and/or compensate for signal propagation effects. The transmitter may then add a cyclic prefix to the time-domain waveform of the signal. The cyclic prefix may help prevent inter-symbol interference due to propagation channel delay spread. The transmitter may output the resulting signal for transmission, for example, for uplink communications.

Technical problems for uplink communications may include, for example, performing efficient signal processing operations, for example, in terms of power consumption, processing time, usage of computational resources (e.g., processor usage and/or memory usage), and/or the like. First, the signal processing operations described herein may be performed at a UE in a non-trivial amount of time. In addition, certain signal processing operations performed at the transmitter may be dependent upon each other, such as MIMO layer mapping being performed after the symbol conversion or the like. In certain cases, an interruption to the signal processing operations (such as a cancellation to a transmission due to scheduling of another higher priority transmission) may cause the UE to consume a non-trivial amount of power and/or computational resources for the cancelled transmission. In certain cases, a modification to a transmission (such as multiplexing uplink control information (UCI) with a data payload) may cause the UE to restart the signal processing operations, resulting in the UE using a non-trivial amount of power and/or computational resources. In certain cases, a modification to the transmission (such as scheduling another transmission on a different carrier) may update the transmit power or other transmission properties, causing the UE to restart the signal processing operations. Due to the possibility of a modification or cancellation to a transmission, the UE may start performing the signal processing operations at a time that is relatively close to when the transmission is scheduled in an effort to avoid such modification or cancellation. To perform the signal processing operations in such a short time, the UE may operate a processor at a higher processing frequency (e.g., clock speed), which in turn may use more power and/or computational resources.

Certain aspects described herein may overcome the aforementioned technical problem(s), for example, by providing techniques for communicating a mutability associated with an uplink grant. As an example, when an uplink transmission is scheduled as being immutable, modification and/or cancellation of the immutable uplink transmission may not be allowed. For example, for an immutable uplink transmission, no other uplink transmission may be scheduled at a UE after receiving the grant or overlapping in time with the immutable uplink transmission. In certain aspects, the payload for the immutable uplink transmission may be fixed or static. For example, other information (such as UCI) may not be allowed to be multiplexed with the payload of the immutable uplink transmission. In certain aspects, the immutable uplink transmission may not be allowed to be cancelled or dropped.

Certain techniques for communication via an immutable uplink transmission described herein may provide various beneficial technical effects and/or advantages. The techniques for communication via an immutable uplink transmission may enable improved wireless communications performance, such as improved power consumption, reduced complexity, improved reliability, and/or the like. The improved power consumption and/or reduced complexity may be attributable to the immutable uplink transmission, for example, due to the immutable uplink transmission enabling an increased processing time for signal processing operations. Such an increased processing time may enable a UE to be equipped with a processor that operates at reduced processing frequencies (e.g., clock speed), and thus, reduced power. The improved reliability may be attributable to the immutable uplink transmission that allows a UE to perform the signal processing operations without interruptions and/or modifications, which may cause signal processing failures and/or increased usage of processing resources.

### Introduction to Wireless Communications Networks

The techniques and methods described herein may be used for various wireless communications networks. While aspects may be described herein using terminology commonly associated with 3G, 4G, 5G, 6G, and/or other generations of wireless technologies, aspects of the present disclosure may likewise be applicable to other communications systems and standards not explicitly mentioned herein.

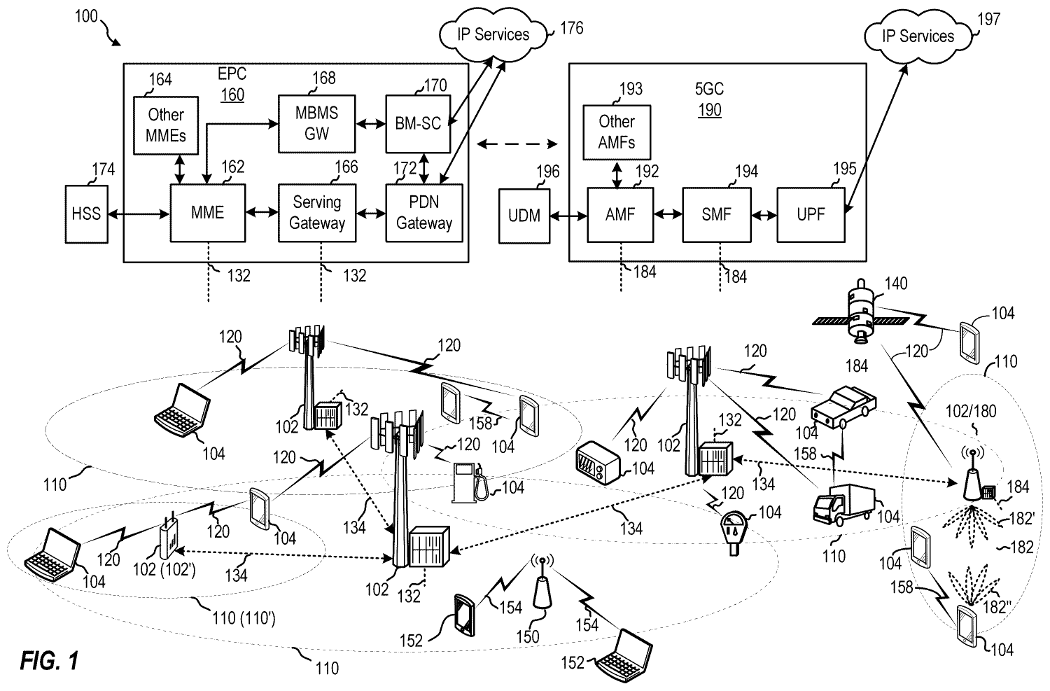

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). As such communications devices are part of wireless communications network 100, and facilitate wireless communications, such communications devices may be referred to as wireless communications devices. For example, various functions of a network as well as various devices associated with and interacting with a network may be considered network entities. Further, wireless communications network 100 includes terrestrial aspects, such as ground-based network entities (e.g., BSs 102), and non-terrestrial aspects (also referred to herein as non-terrestrial network entities), such as satellite 140 and/or aerial or spaceborne platform(s), which may include network entities on-board (e.g., one or more BSs) capable of communicating with other network elements (e.g., terrestrial BSs) and UEs.

In the depicted example, wireless communications network 100 includes BSs 102, UEs 104, and one or more core networks, such as an Evolved Packet Core (EPC) 160 and 5G Core (5GC) network 190, which interoperate to provide communications services over various communications links, including wired and wireless links.

FIG. 1 depicts various example UEs 104, which may more generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always on (AON) devices, edge processing devices, data centers, or other similar devices. UEs 104 may also be referred to more generally as a mobile device, a wireless device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. The communications links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communications links 120 may use multiple-input and multiple-output (MIMO) antenna technology, including spatial multiplexing, beamforming, and/or transmit diversity in various aspects.

BSs 102 may generally include: a NodeB, enhanced NodeB (eNB), next generation enhanced NodeB (ng-eNB), next generation NodeB (gNB or gNodeB), access point, base transceiver station, radio base station, radio transceiver, transceiver function, transmission reception point, and/or others. Each of BSs 102 may provide communications coverage for a respective coverage area 110, which may sometimes be referred to as a cell, and which may overlap in some cases (e.g., small cell 102′ may have a coverage area 110′ that overlaps the coverage area 110 of a macro cell). A BS may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

Generally, a cell may refer to a portion, partition, or segment of wireless communication coverage served by a network entity within a wireless communication network. A cell may have geographic characteristics, such as a geographic coverage area, as well as radio frequency characteristics, such as time and/or frequency resources dedicated to the cell. For example, a specific geographic coverage area may be covered by multiple cells employing different frequency resources (e.g., bandwidth parts) and/or different time resources. As another example, a specific geographic coverage area may be covered by a single cell. In some contexts (e.g., a carrier aggregation scenario and/or multi-connectivity scenario), the terms “cell” or “serving cell” may refer to or correspond to a specific carrier frequency (e.g., a component carrier) used for wireless communications, and a “cell group” may refer to or correspond to multiple carriers used for wireless communications. As examples, in a carrier aggregation scenario, a UE may communicate on multiple component carriers corresponding to multiple (serving) cells in the same cell group, and in a multi-connectivity (e.g., dual connectivity) scenario, a UE may communicate on multiple component carriers corresponding to multiple cell groups.

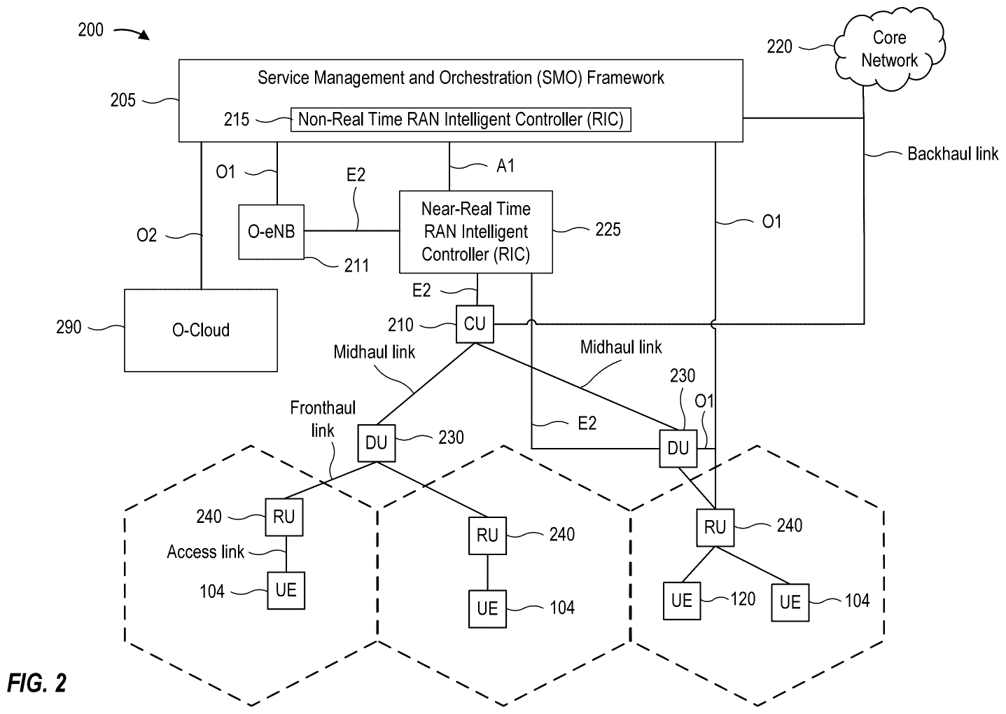

While BSs 102 are depicted in various aspects as unitary communications devices, BSs 102 may be implemented in various configurations. For example, one or more components of a base station may be disaggregated, including a central unit (CU), one or more distributed units (DUs), one or more radio units (RUs), a Near-Real Time (Near-RT) RAN Intelligent Controller (RIC), or a Non-Real Time (Non-RT) RIC, to name a few examples. In another example, various aspects of a base station may be virtualized. More generally, a base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. In some aspects, a base station including components that are located at various physical locations may be referred to as a disaggregated radio access network architecture, such as an Open RAN (O-RAN) or Virtualized RAN (VRAN) architecture. FIG. 2 depicts and describes an example disaggregated base station architecture.

Different BSs 102 within wireless communications network 100 may also be configured to support different radio access technologies, such as 3G, 4G, and/or 5G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or 5GC 190) with each other over third backhaul links 134 (e.g., X2 interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, 3GPP currently defines Frequency Range 1 (FR1) as including 410 MHz-7125 MHz, which is often referred to (interchangeably) as “Sub-6 GHz”. Similarly, 3GPP currently defines Frequency Range 2 (FR2) as including 24,250 MHz-71,000 MHz, which is sometimes referred to (interchangeably) as a “millimeter wave” (“mmW” or “mmWave”). In some cases, FR2 may be further defined in terms of sub-ranges, such as a first sub-range FR2-1 including 24,250 MHz-52,600 MHz and a second sub-range FR2-2 including 52,600 MHz-71,000 MHz. A base station configured to communicate using mmWave/near mmWave radio frequency bands (e.g., a mmWave base station such as BS 180) may utilize beamforming (e.g., 182) with a UE (e.g., 104) to improve path loss and range.

The communications links 120 between BSs 102 and, for example, UEs 104, may be through one or more carriers, which may have different bandwidths (e.g., 5, 10, 15, 20, 100, 400, and/or other MHz), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., 180 in FIG. 1) may utilize beamforming 182 with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may then perform beam training to determine the best receive and transmit directions for each of BS 180 and UE 104. Notably, the transmit and receive directions for BS 180 may or may not be the same. Similarly, the transmit and receive directions for UE 104 may or may not be the same.

Wireless communications network 100 further includes a Wi-Fi AP 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172, such as in the depicted example. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, including: an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and 5GC 190. AMF 192 provides, for example, quality of service (QoS) flow and session management.

Internet protocol (IP) packets are transferred through UPF 195, which is connected to the IP Services 197, and which provides UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a sidelink node, to name a few examples.

FIG. 2 depicts an example disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUs) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUs 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more DUs 230 and/or one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

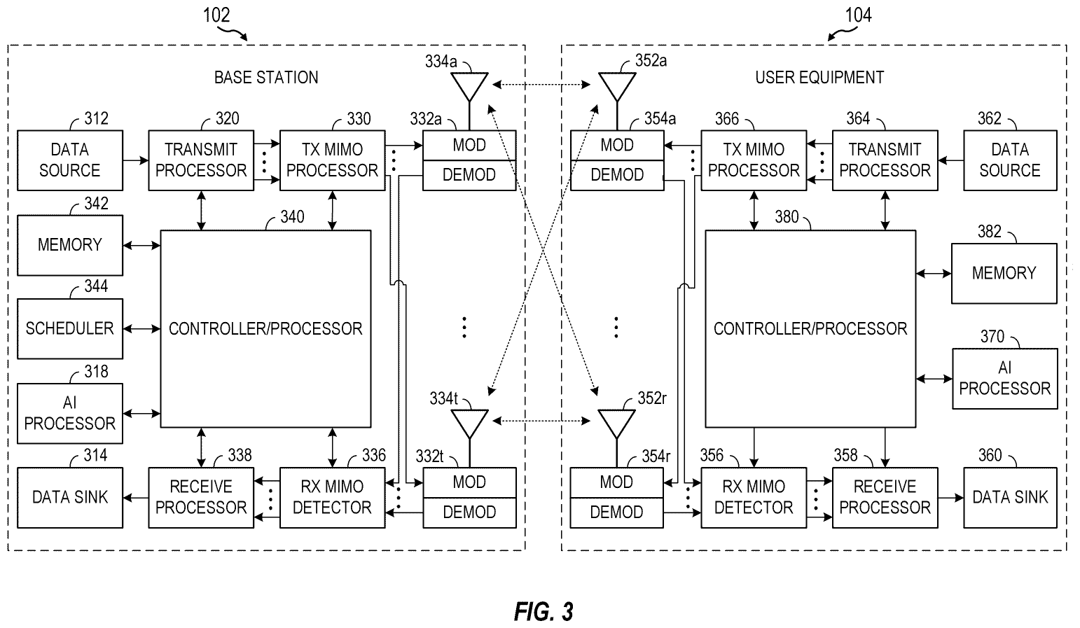

FIG. 3 depicts aspects of an example BS 102 and a UE 104.

Generally, BS 102 includes various processors (e.g., 318, 320, 330, 338, and 340), antennas 334a-t (collectively 334), transceivers 332a-t (collectively 332), which include modulators and demodulators, and other aspects, which enable wireless transmission of data (e.g., data source 312) and wireless reception of data (e.g., data sink 314). For example, BS 102 may send and receive data between BS 102 and UE 104. BS 102 includes controller/processor 340, which may be configured to implement various functions described herein related to wireless communications. Note that the BS 102 may have a disaggregated architecture as described herein with respect to FIG. 2.

Generally, UE 104 includes various processors (e.g., 358, 364, 366, 370, and 380), antennas 352a-r (collectively 352), transceivers 354a-r (collectively 354), which include modulators and demodulators, and other aspects, which enable wireless transmission of data (e.g., retrieved from data source 362) and wireless reception of data (e.g., provided to data sink 360). UE 104 includes controller/processor 380, which may be configured to implement various functions described herein related to wireless communications.

In regards to an example downlink transmission, BS 102 includes a transmit processor 320 that may receive data from a data source 312 and control information from a controller/processor 340. The control information may be for the physical broadcast channel (PBCH), physical control format indicator channel (PCFICH), physical hybrid automatic repeat request (HARQ) indicator channel (PHICH), physical downlink control channel (PDCCH), group common PDCCH (GC PDCCH), and/or others. The data may be for the physical downlink shared channel (PDSCH), in some examples.

Transmit processor 320 may process (e.g., encode and symbol map) the data and control information to obtain data symbols and control symbols, respectively. Transmit processor 320 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) in transceivers 332a-332t. Each modulator in transceivers 332a-332t may process a respective output symbol stream to obtain an output sample stream. Each modulator may further process (e.g., convert to analog, amplify, filter, and upconvert) the output sample stream to obtain a downlink signal. Downlink signals from the modulators in transceivers 332a-332t may be transmitted via the antennas 334a-334t, respectively.

In order to receive the downlink transmission, UE 104 includes antennas 352a-352r that may receive the downlink signals from the BS 102 and may provide received signals to the demodulators (DEMODs) in transceivers 354a-354r, respectively. Each demodulator in transceivers 354a-354r may condition (e.g., filter, amplify, downconvert, and digitize) a respective received signal to obtain input samples. Each demodulator may further process the input samples to obtain received symbols.

RX MIMO detector 356 may obtain received symbols from all the demodulators in transceivers 354a-354r, perform MIMO detection on the received symbols if applicable, and provide detected symbols. Receive processor 358 may process (e.g., demodulate, deinterleave, and decode) the detected symbols, provide decoded data for the UE 104 to a data sink 360, and provide decoded control information to a controller/processor 380.

In regards to an example uplink transmission, UE 104 further includes a transmit processor 364 that may receive and process data (e.g., for the PUSCH) from a data source 362 and control information (e.g., for the physical uplink control channel (PUCCH)) from the controller/processor 380. Transmit processor 364 may also generate reference symbols for a reference signal (e.g., for the sounding reference signal (SRS)). The symbols from the transmit processor 364 may be precoded by a TX MIMO processor 366 if applicable, further processed by the modulators in transceivers 354a-354r (e.g., for SC-FDM), and transmitted to BS 102.

At BS 102, the uplink signals from UE 104 may be received by antennas 334a-t, processed by the demodulators in transceivers 332a-332t, detected by a RX MIMO detector 336 if applicable, and further processed by a receive processor 338 to obtain decoded data and control information sent by UE 104. Receive processor 338 may provide the decoded data to a data sink 314 and the decoded control information to the controller/processor 340.

Memories 342 and 382 may store data and program codes for BS 102 and UE 104, respectively.

Scheduler 344 may schedule UEs for data transmission on the downlink and/or uplink.

In various aspects, BS 102 may be described as transmitting and receiving various types of data associated with the methods described herein. In these contexts, “transmitting” may refer to various mechanisms of outputting data, such as outputting data from data source 312, scheduler 344, memory 342, transmit processor 320, controller/processor 340, TX MIMO processor 330, transceivers 332a-t, antenna 334a-t, and/or other aspects described herein. Similarly, “receiving” may refer to various mechanisms of obtaining data, such as obtaining data from antennas 334a-t, transceivers 332a-t, RX MIMO detector 336, controller/processor 340, receive processor 338, scheduler 344, memory 342, and/or other aspects described herein.

In various aspects, UE 104 may likewise be described as transmitting and receiving various types of data associated with the methods described herein. In these contexts, “transmitting” may refer to various mechanisms of outputting data, such as outputting data from data source 362, memory 382, transmit processor 364, controller/processor 380, TX MIMO processor 366, transceivers 354a-t, antenna 352a-t, and/or other aspects described herein. Similarly, “receiving” may refer to various mechanisms of obtaining data, such as obtaining data from antennas 352a-t, transceivers 354a-t, RX MIMO detector 356, controller/processor 380, receive processor 358, memory 382, and/or other aspects described herein.

In some aspects, a processor may be configured to perform various operations, such as those associated with the methods described herein, and transmit (output) to or receive (obtain) data from another interface that is configured to transmit or receive, respectively, the data.

In various aspects, artificial intelligence (AI) processors 318 and 370 may perform AI processing for BS 102 and/or UE 104, respectively. The AI processor 318 may include AI accelerator hardware or circuitry such as one or more neural processing units (NPUs), one or more neural network processors, one or more tensor processors, one or more deep learning processors, etc. The AI processor 370 may likewise include AI accelerator hardware or circuitry. As an example, the AI processor 370 may perform AI-based beam management, AI-based channel state feedback (CSF), AI-based antenna tuning, and/or AI-based positioning (e.g., non-line of sight positioning prediction). In some cases, the AI processor 318 may process feedback from the UE 104 (e.g., CSF) using hardware accelerated AI inferences and/or AI training. The AI processor 318 may decode compressed CSF from the UE 104, for example, using a hardware accelerated AI inference associated with the CSF. In certain cases, the AI processor 318 may perform certain RAN-based functions including, for example, network planning, network performance management, energy-efficient network operations, etc.

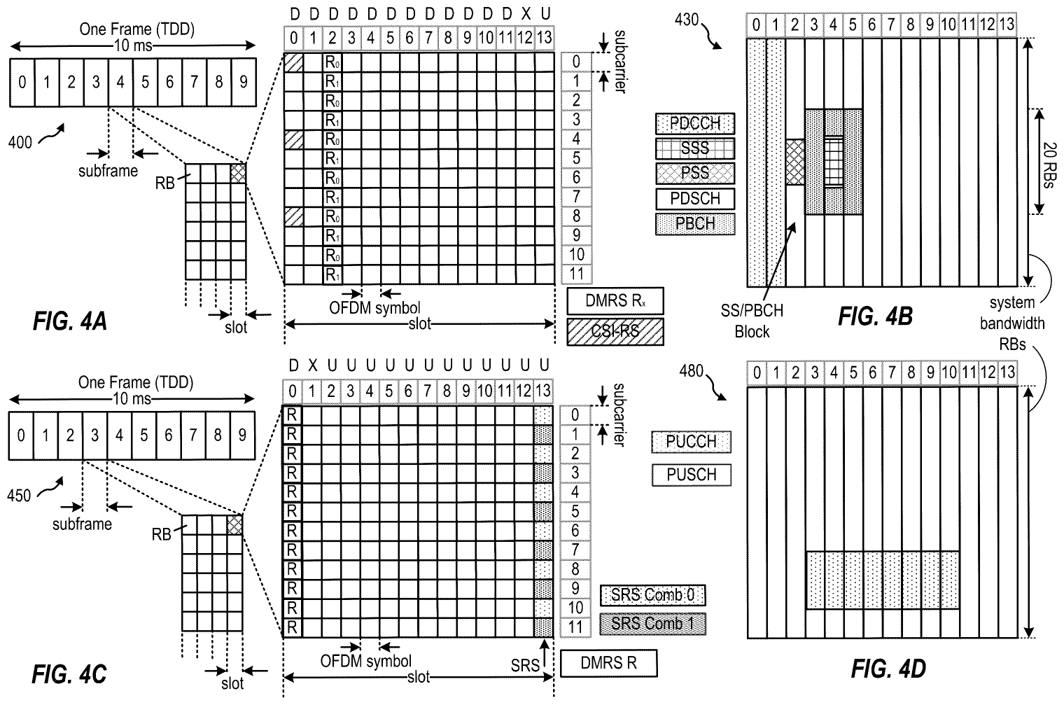

FIGS. 4A, 4B, 4C, and 4D depict aspects of data structures for a wireless communications network, such as wireless communications network 100 of FIG. 1.

In particular, FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for both DL and UL either DL or UL. Wireless communications frame structures may also be time division duplex (TDD), in which, for a particular set of subcarriers, subframes within the set of subcarriers are dedicated for either DL or UL.

In FIGS. 4A and 4C, the wireless communications frame structure is TDD where D is DL, U is UL, and X is flexible for use between DL/UL. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 12 or 14 symbols, depending on the cyclic prefix (CP) type (e.g., 12 symbols per slot for an extended CP or 14 symbols per slot for a normal CP). Subframes may also include mini-slots, which generally have fewer symbols than an entire slot. Other wireless communications technologies may have a different frame structure and/or different channels.

In certain aspects, the number of slots within a subframe (e.g., a slot duration in a subframe) is based on a numerology, which may define a frequency domain subcarrier spacing and symbol duration as further described herein. In certain aspects, given a numerology μ, there are 2^{μ} slots per subframe. Thus, numerologies (μ) 0 to 6 may allow for 1, 2, 4, 8, 16, 32, and 64 slots, respectively, per subframe. In some cases, the extended CP (e.g., 12 symbols per slot) may be used with a specific numerology, e.g., numerology 2 allowing for 4 slots per subframe. The subcarrier spacing and symbol length/duration are a function of the numerology. The subcarrier spacing may be equal to 2^{μ}×15 kHz, where μ is the numerology 0 to 6. As an example, the numerology μ=0 corresponds to a subcarrier spacing of 15 kHz, and the numerology μ=6 corresponds to a subcarrier spacing of 960 kHz. The symbol length/duration is inversely related to the subcarrier spacing. FIGS. 4A, 4B, 4C, and 4D provide an example of a slot format having 14 symbols per slot (e.g., a normal CP) and a numerology μ=2 with 4 slots per subframe. In such a case, the slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme including, for example, quadrature phase shift keying (QPSK) or quadrature amplitude modulation (QAM).

As illustrated in FIG. 4A, some of the REs carry reference (pilot) signals (RS) for a UE (e.g., UE 104 of FIGS. 1 and 3). The RS may include demodulation RS (DMRS) and/or channel state information reference signals (CSI-RS) for channel estimation at the UE. The RS may also include beam measurement RS (BRS), beam refinement RS (BRRS), and/or phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block (SSB), and in some cases, referred to as a synchronization signal block (SSB). The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as R for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Example OFDM Communications System

Certain wireless communication systems may be implemented using orthogonal frequency division multiplexing (OFDM). The fundamental concept of a multicarrier system (such as OFDM) is the division of a data stream into several narrow subcarriers. An OFDM signal is essentially a bundle of narrowband carriers (e.g., subcarriers) transmitted across a carrier bandwidth. Each of the subcarriers conveys information by modulating the phase and/or the amplitude of the subcarrier over a particular symbol duration. For example, each subcarrier may use either phase-shift-keying (PSK) or quadrature-amplitude-modulation (QAM) to convey information.

FIG. 5 depicts an example wireless communications system 500 including an example transmitter chain and an example receiver chain for OFDM communications between a transmitter 502 and a receiver 504 over a wireless communications channel (hereinafter “the channel 540”). In this example, the transmitter 502 modulates a bit stream into symbols according to a digital modulation scheme (e.g., QPSK or QAM) at block 506. The transmitter 502 passes the symbols through a serial-to-parallel converter to divide the symbols into sub-streams at block 508. The sub-streams are mapped to subcarriers through a resource element mapper at block 510. The transmitter 502 determines the in-phase and quadrature components of the time-domain waveform by passing the subcarrier components through an inverse fast Fourier transform (IFFT) at block 512. The parallel sub-streams are converted to the time-domain waveform through a parallel-to-serial converter at block 514. After adding a cyclic prefix (CP) to the time-domain waveform at block 516, the resulting signal can be mixed up to a RF carrier frequency and output by an RF transmitter at block 518. The CP provides a guard period to help prevent inter-symbol interference, which may be caused by a propagation channel delay spread, for example.

The receiver 504 receives the RF signal and then filters and converts the RF signal to a baseband signal via an RF receiver at block 520. The RF signal may be affected by the channel 540, for example, due to various signal propagation effects including path loss, multipath effects, fading, Doppler effects, etc. The baseband signal is converted from an analog signal to a digital signal for demodulation. The digital signal may correspond to the time-domain waveform of the symbols. At block 522, the CP is removed from symbols of the signal. At block 524, the serial stream of symbols is converted to parallel streams of symbols. At block 526, the parallel stream of symbols may be transformed to the frequency domain, for example, using a forward fast Fourier transform (FFT), to recover the amplitude and phase of each subcarrier. The FFT may include any of various types of FFTs, for example, a radix-2 FFT, a radix-4 FFT, a mixed-radix FFT. At block 528, the symbols are translated to resource element(s).

At block 530, a channel estimation is performed to determine various signal propagation effects of the channel 540 associated with the subcarriers of the OFDM signal. The channel estimation may include any of various types of channel estimations, for example, a frequency domain minimum mean square error (MMSE) or a time domain MMSE. As an example, the received signal may include pilot values at certain pilot subcarriers (e.g., DMRS) and information modulated in certain data subcarriers. The pilot values and respective position in the frequency domain (e.g., the pilot carrier index) are known to the receiver 504, and with this information, the receiver 504 can estimate the signal propagation effects of the channel 540 on the pilot subcarriers. Hence, the receiver 504 may estimate (e.g., interpolate) the channel values between the pilot subcarriers and the data subcarriers to determine an estimate of signal propagation effects for the data subcarriers.

At block 532, channel equalization is performed to compensate for certain signal propagation effects of the channel 540 using the channel estimation determined at block 530. The channel equalization may include any of various types of channel equalization, for example, MMSE, blind equalization, adaptive median filter, etc. As an example, noise and/or interference as determined from the channel estimation may be filtered from the data subcarriers. In some cases, the channel equalization may compensate for other effects, such as propagation delay, fading, multipath effects, Doppler effects, etc.

At block 534, the parallel streams of symbols are converted to a serial stream of symbols.

At block 536, the receiver 504 recovers the transmitted bit stream, for example, by converting the symbols to bits. For each of the equalized symbols, the phase and amplitude may be represented as a constellation point. The constellation points of the symbols may form a constellation of complex values representative of a codeword (e.g., a combination of one or more bits). The constellation points are demapped (demodulated or decoded) to transform the constellation points into the codeword or decoded information. As the subcarriers are subjected to various signal propagation effects through the channel 540, the constellation points may have errors (e.g., phase and/or magnitude errors) relative to the expected position of the constellation points. The receiver may perform any of various decoding operations to estimate the data conveyed in the constellation points, such as hard decision decoding (demodulation) or soft decision decoding (demodulation).

As an example, each received constellation point may be compared to a reference constellation point (for example, using an MMSE-based demodulator or a maximum likelihood-based demodulator). The receiver 504 may determine the reference constellation point that is closest to the received point, and the codeword that belongs to the closest reference constellation point may be assigned to the received point. The decoded information may include the one or more codewords decoded among the constellation points for the symbols. The information that is encoded at the transmitter and successfully decoded at the receiver may be called mutual information, which may be indicative of the capacity of the channel 540, for example, the data rate or throughput rate. The various types of decoding operations (e.g., a specific type of FFT, channel estimation, channel equalization, and/or demodulation) may be selected based on the performance of the corresponding operation, such as latency (e.g., computation time), memory usage, number of computations performed, etc.

### Aspects Related to Uplink Grant Mutability

Aspects of the present disclosure provide techniques for communicating a mutability associated with an uplink grant. As modification and/or cancellation of the immutable uplink transmission may not be allowed, the mutability associated with an uplink grant may improve power consumption, reduce complexity, improve reliability, and/or the like.

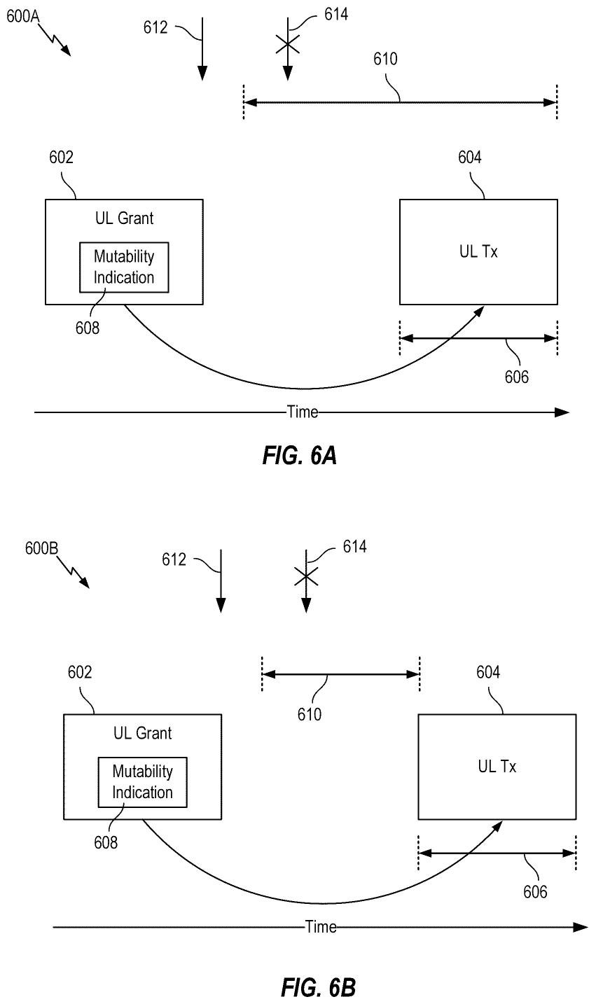

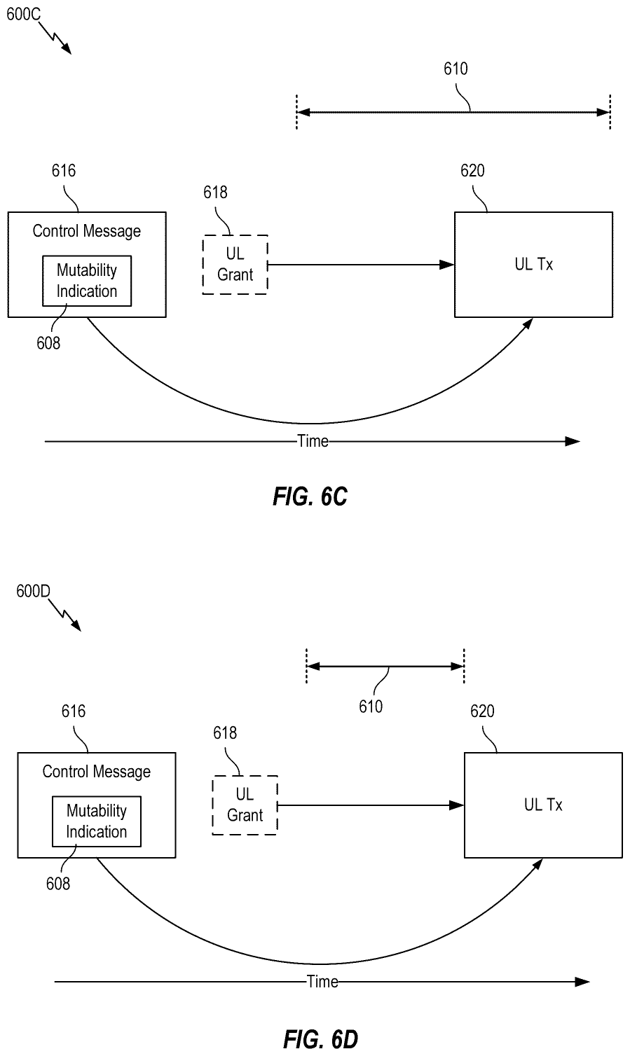

FIGS. 6A and 6B depict example schemes 600A, 600B for communication of a mutability indication via an uplink grant. In these examples, a UE may obtain, from a network entity, an uplink grant 602 that indicates or includes an uplink resource allocation for an uplink transmission 604. In certain aspects, the uplink grant 602 may be or include a dynamic uplink grant, for example, communicated via downlink control information (DCI). In certain aspects, the uplink grant 602 may enable or activate a periodic or semi-static uplink resource allocation. A periodic uplink resource allocation may mean a resource allocation that includes periodic time-frequency resources. A semi-static or semi-persistent uplink resource allocation may mean a resource allocation that includes time-frequency resource(s) that can be activated or deactivated via signaling, where the time-frequency resource(s) may have a periodicity. The uplink resource allocation may indicate time-frequency resource(s) for the UE to use for the uplink transmission 604. For example, the uplink resource allocation may indicate or include at least one transmission occasion 606 (e.g., corresponding to certain time domain resource(s)) during which signaling for the uplink transmission may be communicated. The UE may send signaling, to the network entity, in the transmission occasion 606 according to the uplink resource allocation. The transmission occasion 606 may be for a dynamic resource allocation (e.g., a single PUSCH transmission) or an instance of a periodic or semi-persistent resource allocation.

In certain cases, the uplink grant 602 may indicate or include a mutability indication 608, for example, an indication of a mutability associated with the uplink resource allocation. The mutability associated with the uplink resource allocation may refer to whether the uplink transmission scheduled by the uplink resource allocation can be modified or cancelled, for example, for a certain duration of time. In certain cases, the mutability indication 608 may indicate that the uplink resource allocation (or portion(s) thereof) is either immutable or mutable. As an example, the mutability indication 608 may indicate that the uplink resource allocation is immutable. In certain aspects, certain uplink communications may be treated, by default, as being either immutable or mutable. The mutability indication 608 may indicate that the uplink transmission 604 is mutable or immutable, for example, depending on the default mutability of certain uplink communications.

Note that “immutable uplink transmission” or the like may be used to refer to an uplink communication that is immutable; and “immutable uplink resource allocation” or “immutable uplink grant” may be used to refer to a resource allocation of an uplink communication that is immutable, as further described herein. Likewise, “mutable uplink transmission,” or the like may be used to refer to an uplink communication that is mutable; and “mutable uplink resource allocation,” “mutable uplink grant,” or the like may be used to refer to a resource allocation of an uplink communication that is mutable, as further described herein.

In certain aspects, the uplink grant 602 may explicitly indicate the mutability indication 608. For example, the uplink grant 602 may include a field or parameter that indicates the mutability indication 608. In certain aspects, the uplink grant 602 (e.g., cyclic redundancy check (CRC) information of the uplink grant) may implicitly indicate the mutability indication 608. The CRC information may be or include redundancy information. In certain cases, the uplink grant 602 (e.g., CRC information of the uplink grant) may be scrambled with a specific radio network temporary identifier (RNTI) associated with a mutability (e.g., an immutable uplink grant or a mutable uplink grant). For example, if the UE successfully descrambles the CRC information of the uplink grant 602 using a specific RNTI associated with an immutable uplink grant, the uplink resource allocation of the uplink grant 602 may be treated as being immutable. In certain cases, a specific CRC mask associated with a mutability (e.g., an immutable uplink grant or a mutable uplink grant) may be used to generate the CRC information of the uplink grant. Accordingly, the mutability indication 608 may be indicated via a field of the uplink grant 602, an RNTI used to scramble the CRC information of the uplink grant 602, and/or a CRC mask used to generate the CRC information of the uplink grant 602.

In certain aspects, the mutability of an uplink transmission may be defined according to certain signal processing specification(s), for example, related to modification and/or cancellation of an uplink transmission. The signal processing specification(s) of an immutable uplink transmission may enable improved power consumption, reduced complexity, improved reliability, and/or the like. In some examples, the immutable uplink transmission may ensure the UE that the resources and/or specifications (e.g., transmit power) associated with an upcoming uplink transmission will be without interruption and/or modification. Therefore, a UE having knowledge of an immutable uplink transmission as described herein may begin performing signal processing operations (e.g., for an uplink transmission) early and gain additional processing time, instead of having to wait until very close to the uplink transmission time to perform such signal processing operations (e.g., due to the possibility of an interruption and/or modification that may occur in mutable uplink transmissions). The increased processing time allowed for an immutable uplink transmission may enable a UE to be equipped with one or more processors that operate at reduced processing frequencies (e.g., clock speed) to process a payload for the immutable uplink transmission, and thus, the UE may consume reduced power. The improved reliability may be due to the UE performing signal processing operations, for the immutable uplink transmission, without interruption and/or modification. Thus, an immutable uplink transmission may prevent or mitigate modifications or interruptions that cause signal processing failures, increased usage of processing resources, and/or increased power consumption.

In certain cases, when the UE is scheduled to send an immutable uplink transmission (e.g., via the uplink grant), no other uplink transmission (in the same carrier or different carrier(s)) may be allowed (or expected) to be scheduled for communication at the UE within a first time window 610 relative to the transmission occasion 606 of the uplink resource allocation. Note that the first time window 610 may have any of various durations, for example, depending on the immutable aspect applied to the uplink transmission, as further described herein. The first time window 610 as depicted in FIGS. 6A and 6B may include a time period that occurs (e.g., begins and ends) before the transmission occasion 606, at least partially overlaps in time with the transmission occasion 606, and/or runs to the end of the transmission occasion 606. With respect to scheduled communication(s), only the transmission occasion 606 for the (immutable) uplink transmission 604 may be scheduled to be communicated in the first time window 610. The first time window 610 may be or include a time period during which the UE may (or be expected to) perform certain signal processing operation(s) for the immutable uplink transmission, such as the signal processing operations of the transmitter chain described herein with respect to FIG. 5. For example, the UE may start transforming the bits of a payload 612 to symbols at the beginning of the first time window 610. In certain cases, the first time window 610 of FIG. 6A may fully and/or partially overlap in time with and/or occur prior to the transmission occasion 606. Note that the signal processing operations of FIG. 5 is an example process flow for OFDM-based wireless communications. Aspects of the present disclosure may be applied to other suitable types of signal processing operations for wireless communications. With respect to a mutable uplink transmission, another uplink transmission may be allowed to be scheduled for communication at the UE, for example, during the transmission occasion 606 and/or the first time window 610. The UE may be configured (via pre-configuration or signaling from a network entity) with a duration of the first time window 610.

In certain aspects, for the immutable uplink transmission, no other information (such as UCI) may be allowed to be multiplexed with a payload 612 of the immutable uplink transmission. Only the payload 612 obtained prior to the first time window 610 relative to the transmission occasion 606 may be permitted to be communicated via the time-frequency resource(s) of the uplink resource allocation. In certain cases, the first time window 610 of FIG. 6B may occur before and not overlap in time with the transmission occasion 606. As an example, the payload 612 of the immutable uplink transmission may be obtained (e.g., generated) at the UE prior to the first time window 610. The payload 612 may be or include user plane traffic (e.g., application traffic, web traffic, messaging traffic, multimedia traffic, or the like) and/or control plane traffic (e.g., UCI, CSI, HARQ feedback, MAC signaling, RRC signaling, or the like). In certain aspects, the content and size of the payload 612 may be static or fixed during the first time window 610. Note that certain signal processing operations may transform the payload 612 for uplink transmission. Such a payload may allow the UE to perform certain signal processing operations without having to restart the signal processing operations, such as due to a potential modification to the payload 612 being obtained at the UE during the first time window 610, such as UCI 614. Thus, the UE may effectively be guaranteed that the payload 612 will not change for the immutable uplink transmission(s). With respect to a mutable uplink transmission, other information (such as UCI 614) may be allowed to be multiplexed with the payload 612 for the uplink transmission, for example, during the first time window 610.

In certain aspects, the immutable uplink transmission may not be allowed to be cancelled or dropped, for example, due to scheduling of another transmission (e.g., a transmission with a higher priority). For example, the transmission occasion 606 may be scheduled for uplink transmission without cancellation within the first time window 610. The UE may be effectively guaranteed to send the uplink transmission 604 via the time-frequency resource(s) of the uplink resource allocation. With respect to a mutable uplink transmission, the transmission may be allowed to be cancelled or dropped, for example, due to scheduling of another transmission during the first time window.

In certain aspects, the UE may be configured (via pre-configuration and/or signaling from a network entity) to interpret the mutability indication 608 as including one or more signal processing specifications associated with the mutability described herein. For example, the UE may be configured to interpret or treat the mutability indication 608 for an immutable uplink transmission to mean that other transmissions are not allowed to be scheduled, other information is not allowed to be multiplexed, and/or the immutable uplink transmission is not allowed to be cancelled or dropped. Certain combinations of the signal processing specifications and/or specific signal processing specification(s) may be specified (for example, via signaling from a network entity) or predefined. The UE may obtain an indication of the signal processing specifications to be applied for immutable and/or mutable uplink transmissions.

In certain aspects, the mutability associated with the uplink resource allocation may be based on certain frequency domain resource(s). The UE may be configured (via pre-configuration or signaling) to treat uplink communications via certain frequency domain resource(s) as being either immutable or mutable. The frequency domain resource(s) may be or include, for example, a set of frequency resources (e.g., subcarrier(s) or resource block(s)), a frequency range, a bandwidth part of a carrier (or cell), a carrier, and/or the like. The bandwidth part may be a contiguous frequency range of a channel bandwidth of a carrier. The carrier may be a frequency range of an operating band specified for wireless communications, such as an operating band of FR1 and/or FR2. In certain cases, the mutability indication 608 may indicate that uplink transmission(s) communicated via certain frequency domain resource(s) are either mutable or immutable. The mutability indication 608 may indicate that the mutability of uplink transmissions applies to certain frequency domain resource(s), such as a bandwidth part of a carrier (or cell) and/or the carrier. When the uplink resource allocation includes frequency domain resource(s) in the bandwidth part and/or the carrier associated with the mutability indication 608, the UE may treat the uplink resource allocation as being either mutable or immutable depending on the specific mutability indicated.

In certain aspects, the mutability indication 608 may be applied to a single uplink transmission, a certain set of uplink transmissions, and/or or certain uplink transmission(s) communicated in a second time window. With respect to FIGS. 6A and 6B, the second time window may correspond to the time period of the transmission occasion 606. The transmission occasion 606 may be an example of the second time window that defines the mutability of uplink transmission(s). The UE may be configured (via pre-configuration and/or signaling from a network entity) with the start time and/or end time of the second time window. In certain cases, the second time window may be based on a timer. For example, the UE may treat any or certain uplink transmission(s) communicated in the second time window as being either mutable or immutable (depending on the mutability indication) until a timer expires. The UE may be configured (via pre-configuration and/or signaling from a network entity) with a duration or value for the timer and/or when to start running the timer.

In certain cases, the mutability indication 608 may be semi-static. The mutability indication 608 may be applied to uplink communications until other signaling, indicating otherwise (e.g., that the mutability indication 608 is not to be applied), is communicated (e.g., obtained at the UE). For example, the mutability indication 608 may indicate that a specific mutability is activated or enabled for certain uplink communications, such as uplink communications within a certain frequency range and/or uplink communications for a specific type of uplink traffic or service. Then, the UE may obtain additional signaling that indicates the mutability is deactivated or disabled. In certain cases, the mutability indication 608 may be applied to uplink communications until another uplink grant is communicated (e.g., obtained at the UE).

In certain aspects, the UE may send, to the network entity, capability information related to the mutability of uplink communications. The capability information may be communicated via RRC signaling, MAC signaling, UCI, and/or the like. The UE assistance information may include the capability information. The capability information may indicate or include whether the UE supports an immutable uplink grant and/or whether the UE supports a mutable uplink grant.

The capability information may indicate a time period prior to an uplink transmission (such as the uplink transmission 604) used by the UE to perform signal processing operations for an immutable uplink transmission. The capability information may indicate the time period used to process an uplink communication, at the UE, scheduled with an immutable uplink grant, such as the uplink grant 602. The time period may be a preferred or requested duration of the first time window 610. The time period may be a minimum time period that enables reduced power consumption, improved reliability, and/or the like, for uplink communications. In certain cases, the time period may be shorter than the duration of the first time window 610. For example, the UE may be configured, via signaling from a network entity, with a duration of the first time window 610 that is greater than the time period request via the capability information.

FIGS. 6C and 6D depict example schemes 600C, 600D for communication of a mutability indication via a control message. In these examples, the UE may obtain, from a network entity, a control message 616 (e.g., a RRC signaling, MAC signaling, DCI, and/or the like) that indicates or includes the mutability indication 608. The mutability indication 608 may indicate periodic, semi-static, and/or dynamic mutability for uplink communications. In certain cases, the control message 616 may indicate or include the mutability indication 608 without a specific uplink resource allocation. In certain cases, the control message 616 may indicate or include a periodic or semi-persistent uplink resource allocation and the corresponding mutability indication 608 for the uplink resource allocation. The control message 616 may include one or more mutability indications addressed to a single UE or multiple UEs. For example, the control message 616 may be communicated as a unicast, multicast (or groupcast), or broadcast message. The control message 616 may be communicated via any suitable downlink channel, such as a PDCCH, PDSCH, downlink control channel, and/or the like.

The UE may optionally obtain, from the network entity, an uplink grant 618 that indicates an uplink resource allocation for an uplink transmission 620. The control message 616 may be communicated separately from the uplink grant 618. In certain cases, the uplink grant 618 may reference the mutability indication 608 of the control message 616. For example, the uplink grant 618 may indicate that the mutability indication 608 applies to the uplink resource allocation of the uplink grant 618. The uplink grant 618 may be associated with the mutability indication 608, for example, based on certain aspects of the mutability indication 608, including certain frequency domain resources, the second time window (as discussed above), a periodic application of the mutability indication 608, and/or a semi-static activation of the mutability indication 608, as discussed herein.

### Example Signaling of Uplink Grant Mutability

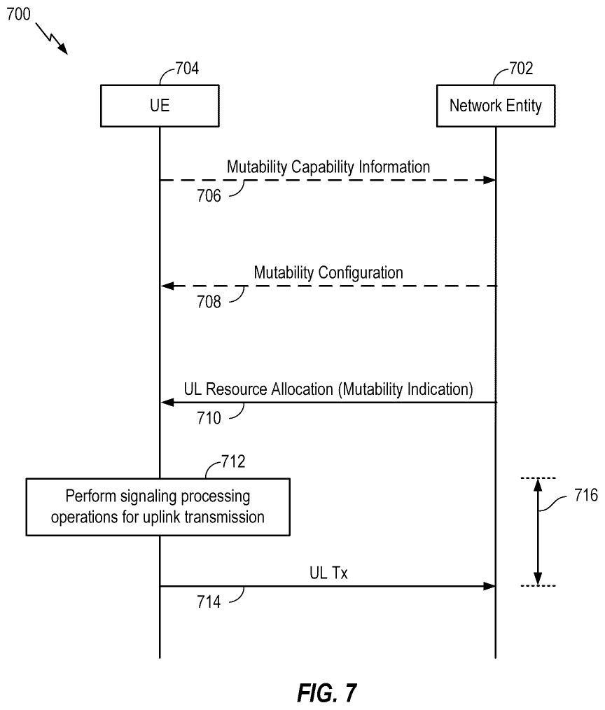

FIG. 7 depicts a process flow 700 for communication of a mutability indication in a network between a network entity 702 and a user equipment (UE) 704. In some aspects, the network entity 702 may be an example of the BS 102 depicted and described with respect to FIGS. 1 and 3 or a disaggregated base station depicted and described with respect to FIG. 2. Similarly, the UE 704 may be an example of UE 104 depicted and described with respect to FIGS. 1 and 3. However, in other aspects, UE 704 may be another type of wireless communications device and network entity 702 may be another type of network entity or network node, such as those described herein. Note that any operations or signaling illustrated with dashed lines may indicate that that operation or signaling is an optional or alternative example.

At 706, the UE 704 optionally sends, to the network entity 702, capability information related to scheduling uplink communications with a mutability indication. As an example, the capability information may indicate or include whether the UE supports an immutable uplink grant and/or whether the UE supports a mutable uplink grant. In certain cases, the capability information may indicate or include the time period used to process an uplink communication, at the UE 704, scheduled with an immutable uplink grant. The capability information may be communicated via RRC signaling, MAC signaling, UCI, and/or the like.

At 708, the UE 704 optionally obtains, from the network entity 702, one or more configuration(s) related to scheduling uplink communications with a mutability indication. In certain aspects, the configuration(s) may be based on the capability information obtained at 706. As an example, the configuration(s) may indicate which signal processing specification defines the mutability of an uplink transmission. For example, the signal processing specification(s) may include one or more of whether other transmissions are allowed to be scheduled within a time window of an immutable uplink transmission, whether other information is allowed to be multiplexed with an immutable uplink transmission, and/or whether an immutable uplink transmission is allowed to be cancelled or dropped. The configuration(s) may indicate or include the duration of the time window relative (e.g., the time window 716) to a transmission occasion of an immutable uplink transmission during which immutable signal processing operations are expected to be performed by a UE. The configuration(s) may indicate or include a time window and/or a set of frequency resources (e.g., a frequency range) in which uplink communications are treated as being immutable or mutable. The configuration(s) may indicate or include a periodic or semi-static uplink resource allocation and a corresponding mutability indication. The configuration(s) may indicate or include an RNTI and/or CRC mask used to indicate the mutability associated with an uplink resource allocation. The configuration(s) may be communicated via system information, RRC signaling, MAC signaling, DCI, and/or the like.

At 710, the UE 704 obtains, from the network entity 702, an uplink resource allocation, which may indicate or include a mutability indication (e.g., the mutability indication 608). As an example, the UE 704 may obtain a dynamic uplink resource allocation via DCI including a field that indicates the uplink resource allocation is immutable. In certain cases, the uplink resource allocation may be or include an indication to enable a semi-static uplink resource allocation. In certain cases, the uplink resource allocation may include frequency resource(s) specified as being immutable or mutable.

At 712, the UE 704 performs signal processing operation(s) for the uplink transmission, for example, as described herein with respect to FIG. 5. As an example, the UE 704 may perform signal processing operations for an immutable uplink transmission during the time window 716. In certain cases, the UE 704 may refrain from multiplexing other information with the payload of the uplink transmission during the time window 716. In certain cases, the UE 704 may not cancel or restart the signal processing operations during the time window 716. Accordingly, the signal processing specifications of an immutable uplink transmission may enable improved power consumption at the UE 704, reduced complexity at the UE 704, improved reliability for uplink communications, and/or the like.

At 714, the UE 704 sends, to the network entity 702, signaling according to the uplink resource allocation. As an example, the signaling may carry or include data and/or control signaling. The signaling may be communicated via a physical uplink channel, such as the PUSCH and/or PUCCH.

Note that the process flow illustrated in FIG. 7 is an example of communicating a mutability indication with an uplink resource allocation, and aspects of the present disclosure may be applied to communicating a mutability indication via one or more control messages, for example, as described herein with respect to FIGS. 6C and 6D. Note that the process flow illustrated in FIG. 7 is described herein to facilitate an understanding of communication of a mutability indication, and aspects of the present disclosure may be performed in various manners via alternative or additional signaling and/or operations. In certain aspects, the operations and/or signaling of FIG. 7 may occur in an order different from that described or depicted, and various actions, operations, and/or signaling may be added, omitted, or combined.

### Example Operations of Uplink Grant Mutability

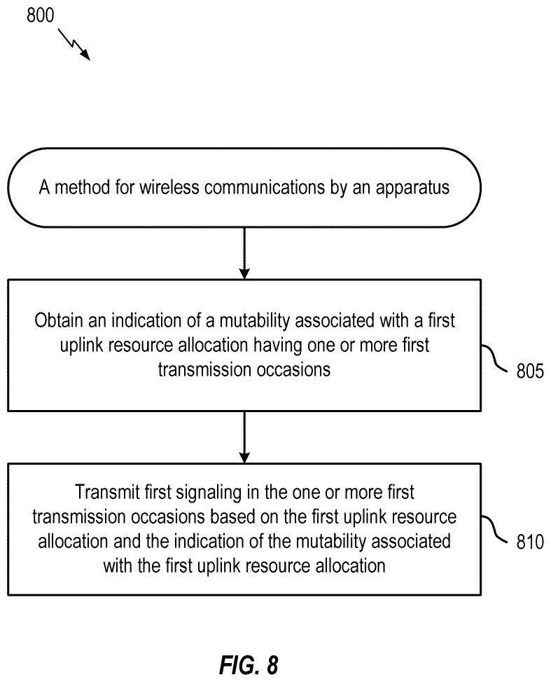

FIG. 8 shows a method 800 for wireless communications by an apparatus, such as UE 104 of FIGS. 1 and 3.

Method 800 begins at block 805 with obtaining an indication of a mutability associated with a first uplink resource allocation having one or more first transmission occasions, for example, as described herein with respect to FIGS. 6A-7. The one or more first transmission occasions may be for dynamic, periodic, and/or semi-persistent uplink communications.

Method 800 then proceeds to block 810 with transmitting first signaling in the one or more first transmission occasions based on the first uplink resource allocation and the indication of the mutability associated with the first uplink resource allocation, for example, as described herein with respect to FIGS. 6A-7.

In certain aspects, the indication of the mutability associated with the first uplink resource allocation indicates that the first uplink resource allocation is immutable.

In certain aspects, the indication of the mutability associated with the first uplink resource allocation further indicates that only the one or more first transmission occasions are scheduled for uplink transmission via one or more carriers in a time window (e.g., the first time window 610) relative to the one or more first transmission occasions. In certain aspects, the time window overlaps in time with the one or more first transmission occasions. In certain aspects, the time window includes a time period that occurs before the one or more first transmission occasions. In certain aspects, the first uplink resource allocation includes one or more frequency resources within the one or more carriers. In certain aspects, the first uplink resource allocation includes one or more frequency resources within a first carrier, and the one or more carriers includes a second carrier.

In certain aspects, the indication of the mutability associated with the first uplink resource allocation further indicates that only a payload obtained in a time window relative to the one or more first transmission occasions is permitted to be communicated via the first uplink resource allocation.

In certain aspects, the indication of the mutability associated with the first uplink resource allocation further indicates that the one or more first transmission occasions are scheduled for uplink transmission without cancellation within a time window relative to the one or more first transmission occasions.

In certain aspects, the indication of the mutability associated with the first uplink resource allocation includes an indication that at least one uplink transmission via a set of frequency resources is immutable, and the first uplink resource allocation includes one or more frequency resources in the set of frequency resources.

In certain aspects, block 805 includes obtaining an indication of the first uplink resource allocation comprising the indication of the mutability associated with the first uplink resource allocation.

In certain aspects, method 800 further includes obtaining, via second signaling, an indication of the first uplink resource allocation; and wherein block 805 includes obtaining, via third signaling, the indication of the mutability associated with the first uplink resource allocation.

In certain aspects, the indication of the mutability associated with the first uplink resource allocation includes an indication that at least one uplink transmission scheduled within a time window is immutable; and the one or more first transmission occasions are within the time window.

In certain aspects, the indication of the mutability associated with the first uplink resource allocation includes an indication that at least one uplink transmission scheduled while a timer is running is immutable; and the first uplink resource allocation is scheduled while the timer is running.

In certain aspects, the indication of the mutability associated with the first uplink resource allocation includes an indication that at least one uplink transmission scheduled is immutable until second signaling, indicating otherwise, is communicated.

In certain aspects, the indication of the mutability associated with the first uplink resource allocation includes an indication that at least one uplink transmission scheduled is immutable until second signaling, which includes an indication of a second uplink resource allocation, is communicated.

In certain aspects, method 800 further includes transmitting an indication that the apparatus is capable of uplink communications scheduled with an immutable uplink grant.

In certain aspects, method 800 further includes transmitting an indication of a time period used for processing of an uplink communication scheduled with an immutable uplink grant.

In certain aspects, the indication of the mutability associated with the first uplink resource allocation indicates that the first uplink resource allocation is mutable.

In certain aspects, the indication of the mutability associated with the first uplink resource allocation includes an indication that at least one uplink transmission via a set of frequency resources is mutable; and the first uplink resource allocation includes one or more frequency resources in the set of frequency resources.

In certain aspects, the indication of the mutability associated with the first uplink resource allocation includes an indication that a first uplink transmission via a first set of frequency resources is mutable, and a second uplink transmission via a second set of frequency resources is immutable.

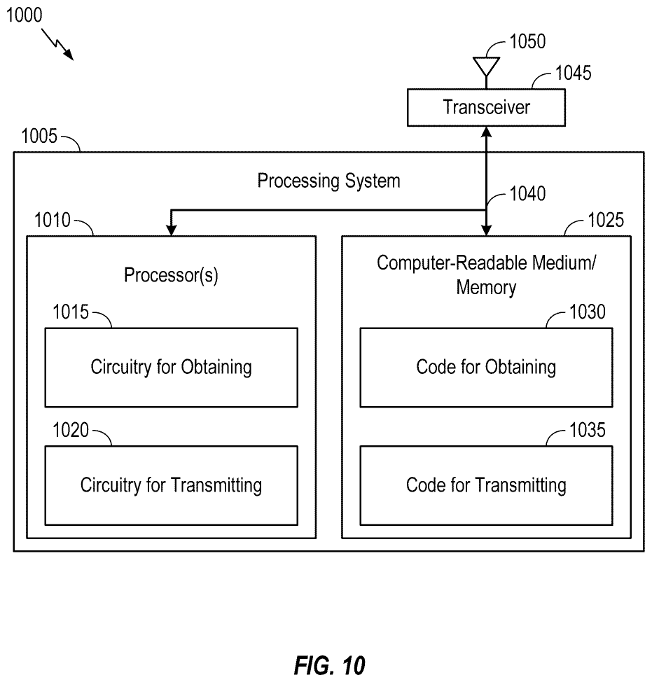

In certain aspects, method 800, or any aspect related to it, may be performed by an apparatus, such as communications device 1000 of FIG. 10, which includes various components operable, configured, or adapted to perform the method 800. Communications device 1000 is described below in further detail.

Note that FIG. 8 is just one example of a method, and other methods including fewer, additional, or alternative operations are possible consistent with this disclosure.

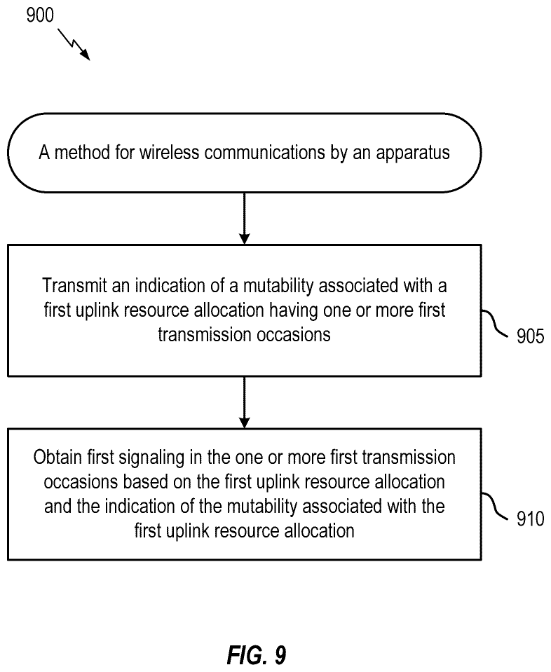

FIG. 9 shows a method 900 for wireless communications by an apparatus, such as BS 102 of FIGS. 1 and 3, or a disaggregated base station as discussed with respect to FIG. 2.

Method 900 begins at block 905 with transmitting an indication of a mutability associated with a first uplink resource allocation having one or more first transmission occasions, for example, as described herein with respect to FIGS. 6A-7. The one or more first transmission occasions may be for dynamic, periodic, and/or semi-persistent uplink communications.

Method 900 then proceeds to block 910 with obtaining first signaling in the one or more first transmission occasions based on the first uplink resource allocation and the indication of the mutability associated with the first uplink resource allocation, for example, as described herein with respect to FIGS. 6A-7.

In certain aspects, the indication of the mutability associated with the first uplink resource allocation indicates that the first uplink resource allocation is immutable.

In certain aspects, the indication of the mutability associated with the first uplink resource allocation further indicates that only the one or more first transmission occasions are scheduled for uplink transmission via one or more carriers in a time window relative to the one or more first transmission occasions. In certain aspects, the time window overlaps in time with the one or more first transmission occasions. In certain aspects, the time window includes a time period that occurs before the one or more first transmission occasions. In certain aspects, the first uplink resource allocation includes one or more frequency resources within the one or more carriers. In certain aspects, the first uplink resource allocation includes one or more frequency resources within a first carrier, and the one or more carriers includes a second carrier.

In certain aspects, the indication of the mutability associated with the first uplink resource allocation further indicates that only a payload obtained in a time window relative to the one or more first transmission occasions is permitted to be communicated via the first uplink resource allocation.

In certain aspects, the indication of the mutability associated with the first uplink resource allocation further indicates that the one or more first transmission occasions are scheduled for uplink transmission without cancellation within a time window relative to the one or more first transmission occasions.

In certain aspects, the indication of the mutability associated with the first uplink resource allocation includes an indication that at least one uplink transmission via a set of frequency resources is immutable, and the first uplink resource allocation includes one or more frequency resources in the set of frequency resources.

In certain aspects, block 905 includes transmitting an indication of the first uplink resource allocation comprising the indication of the mutability associated with the first uplink resource allocation.

In certain aspects, method 900 further includes transmitting, via second signaling, an indication of the first uplink resource allocation; and wherein block 905 includes transmitting, via third signaling, the indication of the mutability associated with the first uplink resource allocation.

In certain aspects, the indication of the mutability associated with the first uplink resource allocation includes an indication that at least one uplink transmission scheduled within a time window is immutable; and the one or more first transmission occasions are within the time window.

In certain aspects, the indication of the mutability associated with the first uplink resource allocation includes an indication that at least one uplink transmission scheduled while a timer is running is immutable; and the first uplink resource allocation is scheduled while the timer is running.

In certain aspects, the indication of the mutability associated with the first uplink resource allocation includes an indication that at least one uplink transmission scheduled is immutable until second signaling, indicating otherwise, is communicated.

In certain aspects, the indication of the mutability associated with the first uplink resource allocation includes an indication that at least one uplink transmission scheduled is immutable until second signaling, which includes an indication of a second uplink resource allocation, is communicated.

In certain aspects, method 900 further includes obtaining an indication that a user equipment is capable of uplink communications scheduled with an immutable uplink grant.

In certain aspects, method 900 further includes obtaining an indication of a time period used for processing of an uplink communication scheduled with an immutable uplink grant.

In certain aspects, the indication of the mutability associated with the first uplink resource allocation indicates that the first uplink resource allocation is mutable.

In certain aspects, the indication of the mutability associated with the first uplink resource allocation includes an indication that at least one uplink transmission via a set of frequency resources is mutable; and the first uplink resource allocation includes one or more frequency resources in the set of frequency resources.

In certain aspects, the indication of the mutability associated with the first uplink resource allocation includes an indication that a first uplink transmission via a first set of frequency resources is mutable, and a second uplink transmission via a second set of frequency resources is immutable.

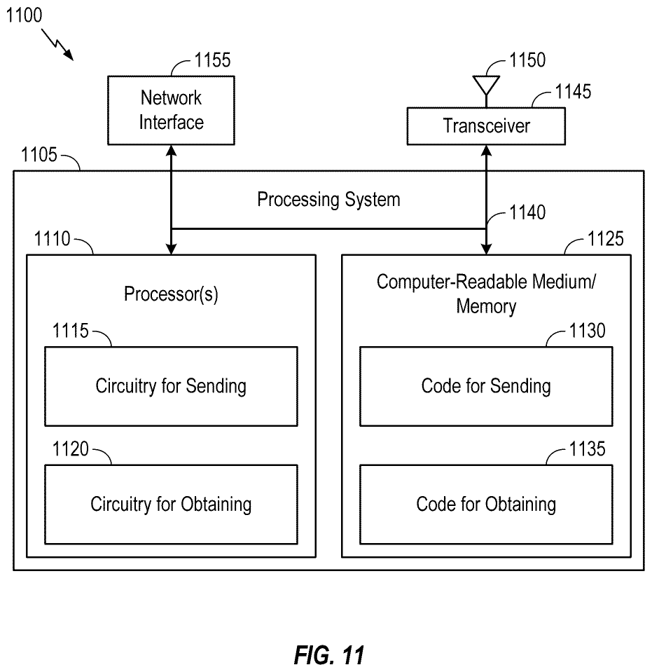

In certain aspects, method 900, or any aspect related to it, may be performed by an apparatus, such as communications device 1100 of FIG. 11, which includes various components operable, configured, or adapted to perform the method 900. Communications device 1100 is described below in further detail.

Note that FIG. 9 is just one example of a method, and other methods including fewer, additional, or alternative operations are possible consistent with this disclosure.

### Example Communications Devices

FIG. 10 depicts aspects of an example communications device 1000. In some aspects, communications device 1000 is a user equipment, such as UE 104 described above with respect to FIGS. 1 and 3.

The communications device 1000 includes a processing system 1005 coupled to a transceiver 1045 (e.g., a transmitter and/or a receiver). The transceiver 1045 is configured to transmit and receive signals for the communications device 1000 via an antenna 1050, such as the various signals as described herein. The processing system 1005 may be configured to perform processing functions for the communications device 1000, including processing signals received and/or to be transmitted by the communications device 1000.

The processing system 1005 includes one or more processors 1010. In various aspects, the one or more processors 1010 may be representative of one or more of receive processor 358, transmit processor 364, TX MIMO processor 366, and/or controller/processor 380, as described with respect to FIG. 3. The one or more processors 1010 are coupled to a computer-readable medium/memory 1025 via a bus 1040. In certain aspects, the computer-readable medium/memory 1025 is configured to store instructions (e.g., computer-executable code), including code 1030 and 1035, that when executed by the one or more processors 1010, enable and cause the one or more processors 1010 to perform the method 800 described with respect to FIG. 8, or any aspect related to it, including any operations described in relation to FIG. 8. Note that reference to a processor performing a function of communications device 1000 may include one or more processors performing that function of communications device 1000, such as in a distributed fashion.

In the depicted example, computer-readable medium/memory 1025 stores code for obtaining 1030 and code for transmitting (or sending) 1035. Processing of the code 1030 and 1035 may enable and cause the communications device 1000 to perform the method 800 described with respect to FIG. 8, or any aspect related to it.

The one or more processors 1010 include circuitry configured to implement (e.g., execute) the code (e.g., executable instructions) stored in the computer-readable medium/memory 1025, including circuitry for obtaining 1015 and circuitry for transmitting 1020. Processing with circuitry 1015 and 1020 may enable and cause the communications device 1000 to perform the method 800 described with respect to FIG. 8, or any aspect related to it.

More generally, means for communicating, transmitting, sending or outputting for transmission may include the transceivers 354, antenna(s) 352, transmit processor 364, TX MIMO processor 366, AI processor 370, and/or controller/processor 380 of the UE 104 illustrated in FIG. 3, transceiver 1045 and/or antenna 1050 of the communications device 1000 in FIG. 10, and/or one or more processors 1010 of the communications device 1000 in FIG. 10. Means for communicating, receiving or obtaining may include the transceivers 354, antenna(s) 352, receive processor 358, AI processor 370, and/or controller/processor 380 of the UE 104 illustrated in FIG. 3, transceiver 1045 and/or antenna 1050 of the communications device 1000 in FIG. 10, and/or one or more processors 1010 of the communications device 1000 in FIG. 10.

FIG. 11 depicts aspects of an example communications device 1100. In some aspects, communications device 1100 is a network entity, such as BS 102 of FIGS. 1 and 3, or a disaggregated base station as discussed with respect to FIG. 2.

The communications device 1100 includes a processing system 1105 coupled to a transceiver 1145 (e.g., a transmitter and/or a receiver) and/or a network interface 1155. The transceiver 1145 is configured to transmit and receive signals for the communications device 1100 via an antenna 1150, such as the various signals as described herein. The network interface 1155 is configured to obtain and send signals for the communications device 1100 via communications link(s), such as a backhaul link, midhaul link, and/or fronthaul link as described herein, such as with respect to FIG. 2. The processing system 1105 may be configured to perform processing functions for the communications device 1100, including processing signals received and/or to be transmitted by the communications device 1100.

The processing system 1105 includes one or more processors 1110. In various aspects, one or more processors 1110 may be representative of one or more of receive processor 338, transmit processor 320, TX MIMO processor 330, and/or controller/processor 340, as described with respect to FIG. 3. The one or more processors 1110 are coupled to a computer-readable medium/memory 1125 via a bus 1140. In certain aspects, the computer-readable medium/memory 1125 is configured to store instructions (e.g., computer-executable code), including code 1130 and 1135, that when executed by the one or more processors 1110, enable and cause the one or more processors 1110 to perform the method 900 described with respect to FIG. 9, or any aspect related to it, including any operations described in relation to FIG. 9. Note that reference to a processor of communications device 1100 performing a function may include one or more processors of communications device 1100 performing that function, such as in a distributed fashion.

In the depicted example, the computer-readable medium/memory 1125 stores code for transmitting 1130 and code for obtaining 1135. Processing of the code 1130 and 1135 may enable and cause the communications device 1100 to perform the method 900 described with respect to FIG. 9, or any aspect related to it.

The one or more processors 1110 include circuitry configured to implement (e.g., execute) the code (e.g., executable instructions) stored in the computer-readable medium/memory 1125, including circuitry for transmitting 1115 and circuitry for obtaining 1120. Processing with circuitry 1115 and 1120 may enable and cause the communications device 1100 to perform the method 900 described with respect to FIG. 9, or any aspect related to it.

Various components of the communications device 1100 may provide means for performing the method 900 described with respect to FIG. 9, or any aspect related to it. Means for communicating, transmitting, sending or outputting for transmission may include the transceivers 332, antenna(s) 334, transmit processor 320, TX MIMO processor 330, AI processor 318, and/or controller/processor 340 of the BS 102 illustrated in FIG. 3, transceiver 1145, antenna 1150, and/or network interface 1155 of the communications device 1100 in FIG. 11, and/or one or more processors 1110 of the communications device 1100 in FIG. 11. Means for communicating, receiving or obtaining may include the transceivers 332, antenna(s) 334, receive processor 338, AI processor 318, and/or controller/processor 340 of the BS 102 illustrated in FIG. 3, transceiver 1145, antenna 1150, and/or network interface 1155 of the communications device 1100 in FIG. 11, and/or one or more processors 1110 of the communications device 1100 in FIG. 11.

### Example Clauses

Implementation examples are described in the following numbered clauses:
Clause 1: A method for wireless communications by an apparatus comprising: obtaining an indication of a mutability associated with a first uplink resource allocation having one or more first transmission occasions; and transmitting first signaling in the one or more first transmission occasions based on the first uplink resource allocation and the indication of the mutability associated with the first uplink resource allocation.
Clause 2: The method of Clause 1, wherein the indication of the mutability associated with the first uplink resource allocation indicates that the first uplink resource allocation is immutable.
Clause 3: The method of Clause 2, wherein the indication of the mutability associated with the first uplink resource allocation further indicates that only the one or more first transmission occasions are scheduled for uplink transmission via one or more carriers in a time window relative to the one or more first transmission occasions.
Clause 4: The method of Clause 3, wherein the time window overlaps in time with the one or more first transmission occasions.
Clause 5: The method of Clause 3 or 4, wherein the time window includes a time period that occurs before the one or more first transmission occasions.
Clause 6: The method of any one of Clauses 3-5, wherein the first uplink resource allocation includes one or more frequency resources within the one or more carriers.
Clause 7: The method of any one of Clauses 3-6, wherein: the first uplink resource allocation includes one or more frequency resources within a first carrier, and the one or more carriers includes a second carrier.
Clause 8: The method of any one of Clauses 2-7, wherein the indication of the mutability associated with the first uplink resource allocation further indicates that only a payload obtained in a time window relative to the one or more first transmission occasions is permitted to be communicated via the first uplink resource allocation.
Clause 9: The method of any one of Clauses 2-8, wherein the indication of the mutability associated with the first uplink resource allocation further indicates that the one or more first transmission occasions are scheduled for uplink transmission without cancellation within a time window relative to the one or more first transmission occasions.
Clause 10: The method of any one of Clauses 1-9, wherein: the indication of the mutability associated with the first uplink resource allocation includes an indication that at least one uplink transmission via a set of frequency resources is immutable, and the first uplink resource allocation includes one or more frequency resources in the set of frequency resources.
Clause 11: The method of any one of Clauses 1-10, wherein obtaining the indication of the mutability associated with the first uplink resource allocation comprises obtaining an indication of the first uplink resource allocation comprising the indication of the mutability associated with the first uplink resource allocation.
Clause 12: The method of any one of Clauses 1-11, further comprising: obtaining, via second signaling, an indication of the first uplink resource allocation; and wherein obtaining the indication of the mutability associated with the first uplink resource allocation comprises obtaining, via third signaling, the indication of the mutability associated with the first uplink resource allocation.
Clause 13: The method of any one of Clauses 1-12, wherein: the indication of the mutability associated with the first uplink resource allocation includes an indication that at least one uplink transmission scheduled within a time window is immutable; and the one or more first transmission occasions are within the time window.
Clause 14: The method of any one of Clauses 1-13, wherein: the indication of the mutability associated with the first uplink resource allocation includes an indication that at least one uplink transmission scheduled while a timer is running is immutable; and the first uplink resource allocation is scheduled while the timer is running.
Clause 15: The method of any one of Clauses 1-14, wherein the indication of the mutability associated with the first uplink resource allocation includes an indication that at least one uplink transmission scheduled is immutable until second signaling, indicating otherwise, is communicated.
Clause 16: The method of any one of Clauses 1-15, wherein the indication of the mutability associated with the first uplink resource allocation includes an indication that at least one uplink transmission scheduled is immutable until second signaling, which includes an indication of a second uplink resource allocation, is communicated.
Clause 17: The method of any one of Clauses 1-16, further comprising transmitting an indication that the apparatus is capable of uplink communications scheduled with an immutable uplink grant.
Clause 18: The method of any one of Clauses 1-17, further comprising transmitting an indication of a time period used for processing of an uplink communication scheduled with an immutable uplink grant.
Clause 19: The method of any one of Clauses 1-18, wherein the indication of the mutability associated with the first uplink resource allocation indicates that the first uplink resource allocation is mutable.
Clause 20: The method of any one of Clauses 1-19, wherein: the indication of the mutability associated with the first uplink resource allocation includes an indication that at least one uplink transmission via a set of frequency resources is mutable; and the first uplink resource allocation includes one or more frequency resources in the set of frequency resources.
Clause 21: The method of any one of Clauses 1-20, wherein the indication of the mutability associated with the first uplink resource allocation includes an indication that a first uplink transmission via a first set of frequency resources is mutable, and a second uplink transmission via a second set of frequency resources is immutable.
Clause 22: A method for wireless communications by an apparatus comprising: transmitting an indication of a mutability associated with a first uplink resource allocation having one or more first transmission occasions; and obtaining first signaling in the one or more first transmission occasions based on the first uplink resource allocation and the indication of the mutability associated with the first uplink resource allocation.
Clause 23: The method of Clause 22, wherein the indication of the mutability associated with the first uplink resource allocation indicates that the first uplink resource allocation is immutable.
Clause 24: The method of Clause 23, wherein the indication of the mutability associated with the first uplink resource allocation further indicates that only the one or more first transmission occasions are scheduled for uplink transmission via one or more carriers in a time window relative to the one or more first transmission occasions.
Clause 25: The method of Clause 24, wherein the time window overlaps in time with the one or more first transmission occasions.
Clause 26: The method of Clause 24 or 25, wherein the time window includes a time period that occurs before the one or more first transmission occasions.
Clause 27: The method of any one of Clauses 24-26, wherein the first uplink resource allocation includes one or more frequency resources within the one or more carriers.
Clause 28: The method of any one of Clauses 24-27, wherein: the first uplink resource allocation includes one or more frequency resources within a first carrier, and the one or more carriers includes a second carrier.
Clause 29: The method of any one of Clauses 23-28, wherein the indication of the mutability associated with the first uplink resource allocation further indicates that only a payload obtained in a time window relative to the one or more first transmission occasions is permitted to be communicated via the first uplink resource allocation.
Clause 30: The method of any one of Clauses 23-29, wherein the indication of the mutability associated with the first uplink resource allocation further indicates that the one or more first transmission occasions are scheduled for uplink transmission without cancellation within a time window relative to the one or more first transmission occasions.
Clause 31: The method of any one of Clauses 22-30, wherein: the indication of the mutability associated with the first uplink resource allocation includes an indication that at least one uplink transmission via a set of frequency resources is immutable, and the first uplink resource allocation includes one or more frequency resources in the set of frequency resources.
Clause 32: The method of any one of Clauses 22-31, wherein transmitting the indication of the mutability associated with the first uplink resource allocation comprises transmitting an indication of the first uplink resource allocation comprising the indication of the mutability associated with the first uplink resource allocation.
Clause 33: The method of any one of Clauses 22-32, further comprising: transmitting, via second signaling, an indication of the first uplink resource allocation; and wherein transmitting the indication of the mutability associated with the first uplink resource allocation comprises transmitting, via third signaling, the indication of the mutability associated with the first uplink resource allocation.
Clause 34: The method of any one of Clauses 22-33, wherein: the indication of the mutability associated with the first uplink resource allocation includes an indication that at least one uplink transmission scheduled within a time window is immutable; and the one or more first transmission occasions are within the time window.
Clause 35: The method of any one of Clauses 22-34, wherein: the indication of the mutability associated with the first uplink resource allocation includes an indication that at least one uplink transmission scheduled while a timer is running is immutable; and the first uplink resource allocation is scheduled while the timer is running.
Clause 36: The method of any one of Clauses 22-35, wherein the indication of the mutability associated with the first uplink resource allocation includes an indication that at least one uplink transmission scheduled is immutable until second signaling, indicating otherwise, is communicated.
Clause 37: The method of any one of Clauses 22-36, wherein the indication of the mutability associated with the first uplink resource allocation includes an indication that at least one uplink transmission scheduled is immutable until second signaling, which includes an indication of a second uplink resource allocation, is communicated.
Clause 38: The method of any one of Clauses 22-37, further comprising obtaining an indication that a user equipment is capable of uplink communications scheduled with an immutable uplink grant.
Clause 39: The method of any one of Clauses 22-38, further comprising obtaining an indication of a time period used for processing of an uplink communication scheduled with an immutable uplink grant.
Clause 40: The method of any one of Clauses 22-39, wherein the indication of the mutability associated with the first uplink resource allocation indicates that the first uplink resource allocation is mutable.
Clause 41: The method of any one of Clauses 22-40, wherein: the indication of the mutability associated with the first uplink resource allocation includes an indication that at least one uplink transmission via a set of frequency resources is mutable; and the first uplink resource allocation includes one or more frequency resources in the set of frequency resources.
Clause 42: The method of any one of Clauses 22-41, wherein the indication of the mutability associated with the first uplink resource allocation includes an indication that a first uplink transmission via a first set of frequency resources is mutable, and a second uplink transmission via a second set of frequency resources is immutable.
Clause 43: One or more apparatuses, comprising: one or more memories comprising executable instructions; and one or more processors configured to execute the executable instructions and cause the one or more apparatuses to perform a method in accordance with any one of Clauses 1-42.
Clause 44: One or more apparatuses, comprising: one or more memories; and one or more processors, coupled to the one or more memories, configured to cause the one or more apparatuses to perform a method in accordance with any one of Clauses 1-42.
Clause 45: One or more apparatuses, comprising: one or more memories; and one or more processors, coupled to the one or more memories, configured to perform a method in accordance with any one of Clauses 1-42.
Clause 46: One or more apparatuses, comprising means for performing a method in accordance with any one of Clauses 1-42.
Clause 47: One or more non-transitory computer-readable media comprising executable instructions that, when executed by one or more processors of one or more apparatuses, cause the one or more apparatuses to perform a method in accordance with any one of Clauses 1-42.
Clause 48: One or more computer program products embodied on one or more computer-readable storage media comprising code for performing a method in accordance with any one of Clauses 1-42.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, an AI processor, a digital signal processor (DSP), an ASIC, a field programmable gate array (FPGA) or other programmable logic device (PLD), discrete gate or transistor logic, discrete hardware components, or any combination thereof designed to perform the functions described herein. A general purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining or the like. Also, “determining” may include receiving (e.g., receiving information), accessing (e.g., accessing data in a memory) or the like. Also, “determining” may include resolving, selecting, choosing, establishing or the like.

As used herein, “coupled to” and “coupled with” generally encompass direct coupling and indirect coupling (e.g., including intermediary coupled aspects) unless stated otherwise. For example, stating that a processor is coupled to a memory allows for a direct coupling or a coupling via an intermediary aspect, such as a bus.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Reference to an element in the singular is not intended to mean only one unless specifically so stated, but rather “one or more.” The subsequent use of a definite article (e.g., “the” or “said”) with an element (e.g., “the processor”) is not intended to invoke a singular meaning (e.g., “only one”) on the element unless otherwise specifically stated. For example, reference to an element (e.g., “a processor,” “a controller,” “a memory,” “a transceiver,” “an antenna,” “the processor,” “the controller,” “the memory,” “the transceiver,” “the antenna,” etc.), unless otherwise specifically stated, should be understood to refer to one or more elements (e.g., “one or more processors,” “one or more controllers,” “one or more memories,” “one more transceivers,” etc.). The terms “set” and “group” are intended to include one or more elements, and may be used interchangeably with “one or more.” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions. Unless specifically stated otherwise, the term “some” refers to one or more. All structural and functional equivalents to the elements of the various aspects described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims.

What is claimed is:

1. An apparatus configured for wireless communications, comprising:
one or more memories; and
one or more processors coupled to the one or more memories, the one or more processors being configured to cause the apparatus to:
obtain an indication of a mutability associated with a first uplink resource allocation having one or more first transmission occasions; and
transmit first signaling in the one or more first transmission occasions based on the first uplink resource allocation and the indication of the mutability associated with the first uplink resource allocation.

2. The apparatus of claim 1, wherein the indication of the mutability associated with the first uplink resource allocation indicates that the first uplink resource allocation is immutable.

3. The apparatus of claim 2, wherein the indication of the mutability associated with the first uplink resource allocation further indicates that only the one or more first transmission occasions are scheduled for uplink transmission via one or more carriers in a time window relative to the one or more first transmission occasions.

4. The apparatus of claim 3, wherein the time window overlaps in time with the one or more first transmission occasions.

5. The apparatus of claim 3, wherein the time window includes a time period that occurs before the one or more first transmission occasions.

6. The apparatus of claim 3, wherein the first uplink resource allocation includes one or more frequency resources within the one or more carriers.

7. The apparatus of claim 3, wherein:
the first uplink resource allocation includes one or more frequency resources within a first carrier, and
the one or more carriers includes a second carrier.

8. The apparatus of claim 2, wherein the indication of the mutability associated with the first uplink resource allocation further indicates that only a payload obtained prior to a time window relative to the one or more first transmission occasions is permitted to be communicated via the first uplink resource allocation.

9. The apparatus of claim 2, wherein the indication of the mutability associated with the first uplink resource allocation further indicates that the one or more first transmission occasions are scheduled for uplink transmission without cancellation within a time window relative to the one or more first transmission occasions.

10. The apparatus of claim 1, wherein:
the indication of the mutability associated with the first uplink resource allocation includes an indication that at least one uplink transmission via a set of frequency resources is immutable, and
the first uplink resource allocation includes one or more frequency resources in the set of frequency resources.

11. The apparatus of claim 1, wherein to obtain the indication of the mutability associated with the first uplink resource allocation, the one or more processors are configured to cause the apparatus to obtain an indication of the first uplink resource allocation comprising the indication of the mutability associated with the first uplink resource allocation.

12. The apparatus of claim 1, wherein:
the one or more processors are configured to cause the apparatus to obtain, via second signaling, an indication of the first uplink resource allocation; and
wherein to obtain the indication of the mutability associated with the first uplink resource allocation, the one or more processors are configured to cause the apparatus to obtain, via third signaling, the indication of the mutability associated with the first uplink resource allocation.

13. The apparatus of claim 1, wherein:
the indication of the mutability associated with the first uplink resource allocation includes an indication that at least one uplink transmission scheduled within a time window is immutable; and
the one or more first transmission occasions are within the time window.

14. The apparatus of claim 1, wherein:
the indication of the mutability associated with the first uplink resource allocation includes an indication that at least one uplink transmission scheduled while a timer is running is immutable; and
the first uplink resource allocation is scheduled while the timer is running.

15. The apparatus of claim 1, wherein:
the indication of the mutability associated with the first uplink resource allocation includes an indication that at least one uplink transmission scheduled is immutable until second signaling is obtained indicating otherwise.

16. The apparatus of claim 1, wherein:
the indication of the mutability associated with the first uplink resource allocation includes an indication that at least one uplink transmission scheduled is immutable until second signaling, which includes an indication of a second uplink resource allocation, is obtained.

17. The apparatus of claim 1, wherein the one or more processors are configured to cause the apparatus to transmit an indication that the apparatus is capable of uplink communications scheduled with an immutable uplink grant.

18. The apparatus of claim 1, wherein the one or more processors are configured to cause the apparatus to transmit an indication of a time period used for processing of an uplink communication scheduled with an immutable uplink grant.

19. The apparatus of claim 1, wherein the indication of the mutability associated with the first uplink resource allocation indicates that the first uplink resource allocation is mutable.

20. An apparatus configured for wireless communications, comprising:
one or more memories; and
one or more processors coupled to the one or more memories, the one or more processors being configured to cause the apparatus to:
transmit an indication of a mutability associated with a first uplink resource allocation having one or more first transmission occasions; and
obtain first signaling in the one or more first transmission occasions based on the first uplink resource allocation and the indication of the mutability associated with the first uplink resource allocation.

21. The apparatus of claim 20, wherein the indication of the mutability associated with the first uplink resource allocation indicates that the first uplink resource allocation is immutable.

22. The apparatus of claim 21, wherein the indication of the mutability associated with the first uplink resource allocation further indicates that only the one or more first transmission occasions are scheduled for uplink transmission via one or more carriers in a time window relative to the one or more first transmission occasions.

23. The apparatus of claim 21, wherein the indication of the mutability associated with the first uplink resource allocation further indicates that only a payload obtained prior to a time window relative to the one or more first transmission occasions is permitted to be communicated via the first uplink resource allocation.

24. The apparatus of claim 21, wherein the indication of the mutability associated with the first uplink resource allocation further indicates that the one or more first transmission occasions are scheduled for uplink transmission without cancellation within a time window relative to the one or more first transmission occasions.

25. The apparatus of claim 20, wherein:
the indication of the mutability associated with the first uplink resource allocation includes an indication that at least one uplink transmission via a set of frequency resources is immutable, and
the first uplink resource allocation includes one or more frequency resources in the set of frequency resources.

26. The apparatus of claim 20, wherein to send the indication of the mutability associated with the first uplink resource allocation, the one or more processors are configured to cause the apparatus to send an indication of the first uplink resource allocation comprising the indication of the mutability associated with the first uplink resource allocation.

27. The apparatus of claim 20, wherein:
the one or more processors are configured to cause the apparatus to send, via second signaling, an indication of the first uplink resource allocation; and
wherein to send the indication of the mutability associated with the first uplink resource allocation, the one or more processors are configured to cause the apparatus to send, via third signaling, the indication of the mutability associated with the first uplink resource allocation.

28. The apparatus of claim 20, wherein:
the indication of the mutability associated with the first uplink resource allocation includes an indication that at least one uplink transmission scheduled within a time window is immutable; and
the one or more first transmission occasions are within the time window.

29. A method for wireless communications by an apparatus, comprising:
obtaining an indication of a mutability associated with a first uplink resource allocation having one or more first transmission occasions; and
transmitting first signaling in the one or more first transmission occasions based on the first uplink resource allocation and the indication of the mutability associated with the first uplink resource allocation.

30. A method for wireless communications by an apparatus, comprising:
transmitting an indication of a mutability associated with a first uplink resource allocation having one or more first transmission occasions; and
obtaining first signaling in the one or more first transmission occasions based on the first uplink resource allocation and the indication of the mutability associated with the first uplink resource allocation.
